(19) United States
(12) Patent Application Publication
(10) Pub. No.: US 2004/0093433 A1
(43) Pub. Date: May 13, 2004

(54) Method for group call address of record compression

(76) Inventors: Peter J. Armbruster, Chandler, AZ (US); Nandakishore A. Albal, Scottsdale, AZ (US); Bradley R. Schaefer, Chandler, AZ (US)

Correspondence Address: MOTOROLA, INC., CORPORATE LAW DEPARTMENT - #56-238, 3102 NORTH 56TH STREET, PHOENIX, AZ, 85018, US

(21) Appl. No.: 10/293,879

(22) Filed: Nov. 13, 2002

(51) Int. Cl. G06F 15/16

(52) U.S. Cl. 709/247

(57) ABSTRACT

A method for compressing an address of record (111-117) includes a number of members in a group call (100). A compressed list (120) is generated by listing a common domain name (130), a member ID, a unique index number (121) that represents the member and optionally a presence indicator (131). The compressed list (120) is transmitted (182-186) to each of the members of the group call. When a particular member requests to speak (188) the network transmits (190-194) only the unique index number and optionally the presence information of the requesting member.

### BACKGROUND OF THE INVENTION

The present invention pertains to communication systems and more particularly to communication systems group calls using Session Initiation Protocol.

Current trends in telecommunications are moving toward Internet Protocol (IP) related protocols and processes to perform tasks that used to be performed by circuit based technology. One of these internet protocol related protocols is the Session Initiation Protocol (SIP) which is used to set up, tear down and modify generic communication sessions within a communication system. See IETF RFC 3261 on “Session Initiation Protocol” (SIP). SIP is a control protocol for creating, modifying and terminating communication sessions with one or more participants. These communication sessions include internet multimedia conferences, internet (or any IP network) telephone calls and multimedia distribution. SIP supports communication session descriptions that allow participants to agree on a set of compatible media types. It also supports user mobility by proxying and redirecting requests to the user's current location.

Although SIP is very generic and flexible, it presents problems in that the set up messages are extremely large relative to over-the-air signaling messages used in many cellular systems. As a result it may take a significant period of time to transfer SIP set up and negotiation messages over slow links such as RF links. The slow transfer time results in a slow set up time for communication sessions particularly for group call where the speaker changes.

For example, it takes about one-half second to transfer a typical SIP invite message over a 9600 BPS link. This results in at least a set up time of one second if both initiating and responding equipments are using RF links. This set up time is unacceptable for many applications such as dispatch (group call), where the total set up time must be very fast.

An address of record is used to identify group members and the current speaker in a group call. Group calls are basically one speaker broadcasting to many listeners. Each listener may in turn become the speaker. An address of record (AOR) and is the fully qualified identity plus domain name of a subscriber engaged in a group call. Each subscriber must have a list of the fully qualified domain names of each of the other subscribers engaged in the group call. An indication as to the speaker will constantly change as different subscribes begin to speak and others stop speaking. Thereby, there is introduced large delays due to setup times for interchange of the fully qualified domain names and speaker indication among the subscribers in a group call.

Therefore, it would be highly advantageous to have a method for compressing address of record information among the subscribers engaged in a group call to substantially reduce the message exchanges for changing speakers in the group call.

### BRIEF DESCRIPTION OF THE DRAWING

FIG. 1 is a block diagram of a SIP communication in accordance with the present invention.

FIG. 2 is a layout depicting the address of record for group call identification before and after the compression in accordance with the present invention.

FIG. 3 is a flow diagram of the process.

FIG. 4 is a call flow diagram for group calls using a method for compression in accordance with the present invention.

### DESCRIPTION OF THE PREFERRED EMBODIMENT

The present invention compresses the list of members or subscribers of a group call. These group call members or mobile stations in the preferred embodiment are grouped by domain. That is, each mobile station with the same domain name is grouped together. Distinguishing one member from another of the same domain is accomplished by associating an index with each mobile station or group member.

In another embodiment, a state conveying presence information may be associated with each mobile station or subscriber.

The compressed group call member list is then sent to each mobile station in the group call. This is done at the call setup. As group members begin to speak, speaker arbitration messages and any associated presence information updates are sent to the clients and include only the index of the group call or mobile station. The full address of record that includes many ASCII characters is not sent for each speaker or presence information update.

Additionally, the compressed group call member list may already be located (cached or provisioned) in the network. The initiating mobile station does not provide the complete group list, just a reference or handle to the group call member list.

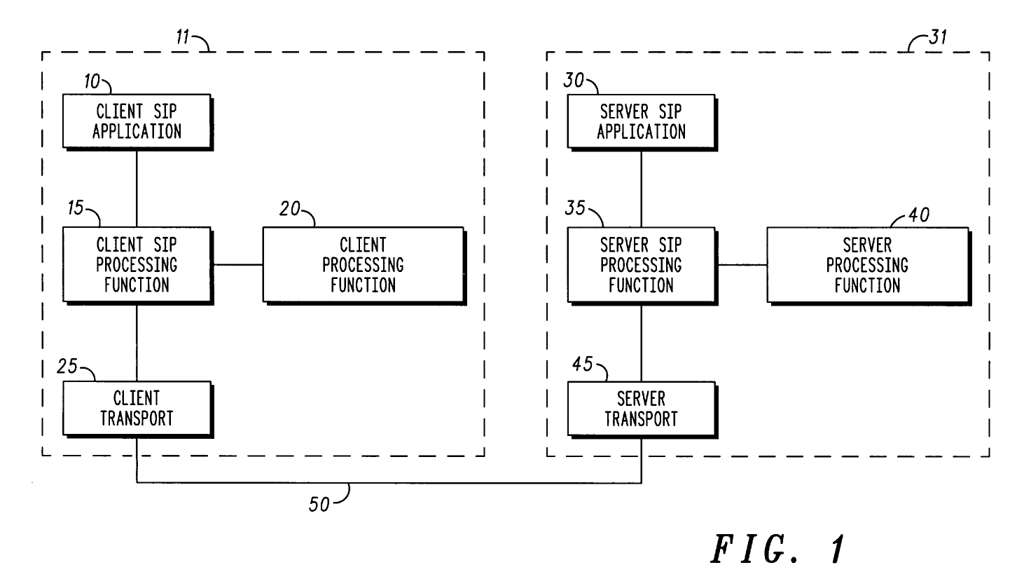

FIG. 1 depicts a block diagram of an arrangement for group member list compression of the group member list over limited bandwidth lengths. Client SIP application 10 requires the services of a server SIP application 30 to initiate a group dispatch call, for example. Typically clients of application 10, which may be a software program in a preferred embodiment, initiates a call to server SIP application 30 with a SIP invite message containing the group members. This invite message includes a header and group member list that is many thousands (four to five thousand) bits of information in length. In response messages are transmitted back and forth over the limited bandwidth link 50. In a preferred embodiment, the limited bandwidth link 50 may comprise an RF (radio frequency) link, using various physical and link layer protocols known in the art.

Client SIP application 10, client SIP processing function 15, client template processing function 20 and client transport collectively may comprise a mobile unit 11. Mobile unit 11 may include such devices as mobile phones, pagers, personal digital assistants or other internet capable devices. Server 31 includes server SIP application 30, server SIP processing function 35, server processing function 40 and server transport 45.

During call setup, client application 10 generates a request for a group call to server SIP application 30. This request is transferred to client SIP processing function 15. Client SIP processing function 15 determines that this request is for a group call for example. Client SIP processing function 15 then transfers the request to the client template processing function 20. Client template processing function 20 determines that the group list requires compression before being transmitted over the limited bandwidth link 50.

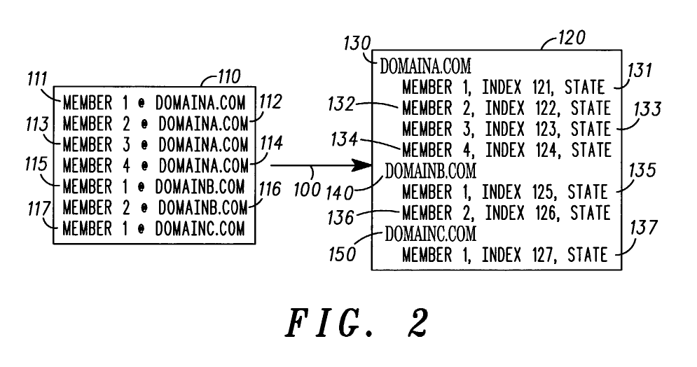

Client processing function 20 then converts or processes the requested group list within the SIP invite message, for example, to be a message as shown in FIG. 2. The fields of this message will be discussed infra. Client template processing function 20 then returns the compressed group list to client processing function 15. Client processing function 15 forwards the compressed group list to client transport 25 within the SIP invite message for transmission over link 50 to the server 31.

Next, server transport 45 receives the compressed message from client transport 25. Server transport 45 forwards the received message to server SIP processing function 35. Server SIP processing function 35 determines that the message contains a compressed group list and forwards the message to server processing function 40 for de-compression. Server template processing function then stores both the compressed and decompressed list. The de-compressed list is then sent to SIP server processing function 35 which forwards the message to SIP server application 30. Server SIP application 30 then acts upon the decompressed list to identify and establish the required group call to each group member, for example. The server application includes the compressed group list within the SIP invite message sent to each group member.

Note the process of sending the group list into the network and initiation the group call are independent processes. The group call member list may be placed into the network by the operator prior to call setup; by a mobile subscriber using the compressed list described above, either prior to the call setup, or as part of call setup; or other methods.

In this way, group member lists sent over the limited bandwidth link 50, in a preferred embodiment an RF link, may be minimized in length and transmission time. This template arrangement saves much time in transmission over the limited bandwidth link 50 and considerably reduces the setup and connect time for clients to initiate and maintain group call services.

An address of record (AOR) is an ASCII text string that defines an individual user, for example, johnsmith@motorola.com. It is a combination of an individual identifier (the johnsmith part) and a domain name (the motorola.com). The individual identifer and the domain name are seperated by the “@” sign.

A fully qualified domain name (FQDN) defines a domain that multiple users “live or operate” and is what follows the “@” sign. The domain motorola.com may serve many users, but is itself insufficient to identify an individual user.

A Universal Resource Identifier (URI) is a SIP term for an AoR.

Referring to FIG. 2, a list 110 of the members of a group call is shown. The identification of each member is their internet “handle”, also known as the Address Of Record. The internet “handle” includes the member's specific name or identification such as member 1 or John Smith, for example; It includes the @ sign and following the @ sign, a domain name, such as marketing.motorola. followed by the “.com” suffix.

For example, there are seven members in the list 110 for this group call. The members are 111-117. Each member is indicated in the internet protocol by a name, member 1 at a domain name.com. For example, Member 111 of the list 110 may be JohnSmith@marketing.motorola.com. Member 115 may be JamesJones@companyx.com. Member 117 may be TomTaylor@companyy.com. For call setup for the group call list 110, the complete list must be sent to each member. As can be seen, the list may comprise many ASCII characters which must be transmitted to all group members as part of call setup. as Additionally, the identification of the current active speaker must be sent to each group member each time there is a change of speaker for indicating the identity of the speaker 111, for example, to the others of the group call 112-117. Speakers may change quite often during a group call. Since it takes quite a bit of time to transmit the entire list to all group members during call setup, and the active talker identification for each change of talker during an active call using session initiation protocol (SIP), the call setup process and the change of speaker identity is slow to take place.

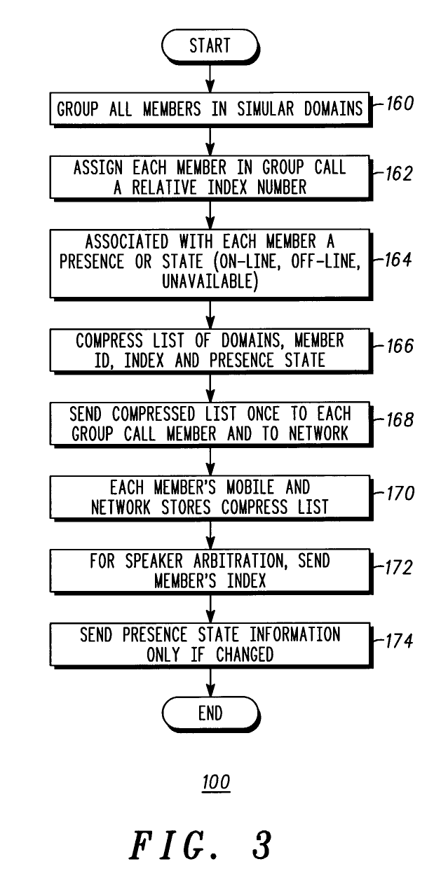

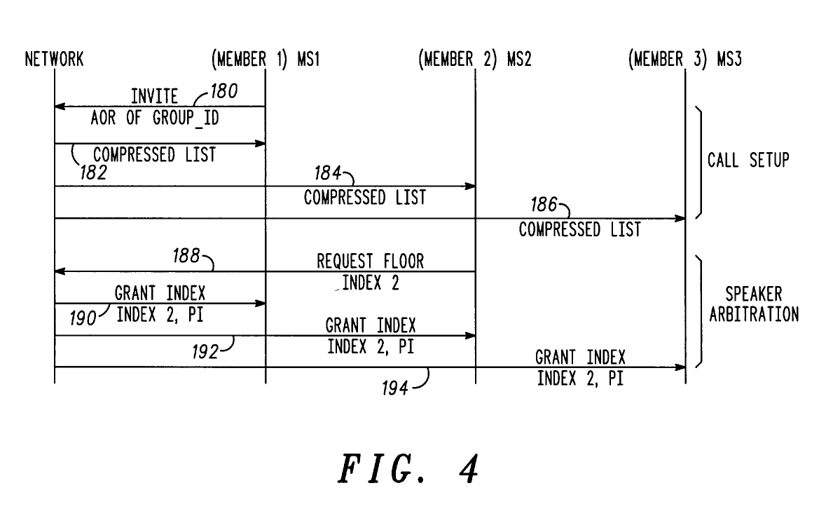

Accordingly, group call list 110 may be compressed 100 into group call list 120. The compression method 100 is shown in detail in FIG. 4. For the compressed list 120 of members of the group call, the result is shown in FIG. 3.

Each domain name 130, 140 and 150 is listed. Domain A.com 130 is marketing.motorola. Domain B.com 140 is Company X. Domain C.com 150 is Company Y. Listed under each domain name are the group call members associated with that domain. For example, Domain A.com has four members; member 1 through member 4. Domain B.com 140 which was Company X, includes members 1 and 2 and similarly Domain C.com 150 includes one member, member 1. Therefore, the compressed list contains the common domain name only once for all group members within that particular domain. Because group calls typically involve many members of a common domain, significant reduction in message size is achieved.

Along with the member number, a relative index number 121-127 is sent along with each member number. Each index 121-127, index 1 through index 7, will represent one of the members of the group call. Each index 121 through 127 will also have a value associated with it which is relative for the present group call. That is, index 1, 121 may be set to 1; index 2, 122 may be set to 2 . . . ; and index 7, 127 may be set to the number 7. The values of the index fields 121-127 although preferably are consecutive numbers, need not be. The chief requirement is that these numbers are unique and map one-to-one to indicate a particular member of the group call. Numbers are preferable since it takes a small amount of bits to represent a large number of members.

Optionally, each member of the group call list 120 may include a state or presence indicator 131-137. The state or presence indicator provide indication of the status or state of each member, such as, on-line, off-line, or not available, etc.

As can be seen by comparison of list 120 to 110, there are considerable fewer ASCII characters used to provide the group call information. The compressed group list results in reduced call setup message size, while the use of the index reduces the size of the talker arbitration messages. As a result rapidly changing speaker Ids may be sent to each of the members of the group call in a faster more compact message than was previously possible. The compressed list 120 for each group call may be stored in the network and in each mobile station or handset. For all subsequent speaker arbitrations or presence updates only the index associated with each member and the presence or state indicator for that member need to be transmitted to the other members of the group call.

Referring to FIG. 3, a flow chart of the compression method 100 and its use is shown. First, all the members are grouped into similar domains, block 160. That is, each of the users in Domain A are grouped, each of the users in Domain B are grouped, etc. Next, each member of the group call is assigned a relative index number, block 162. That is, each of the members in the group call have associated with their member ID a unique number which indicates that particular member within the group call. The relative index number assigned need not be sequential but only unique within the group call. Next a state or presence indicator 131 through 137 may be associated with each member of the group call, block 164. The presence or state indicates on-line, off-line, unavailable, or etc.

Next a compressed list of domain, member ID, index and presence or state indicator is generated for each member of the group call, block 166. This is as shown in list 120 of FIG. 2. Then the compressed list 120 is sent once to each group call member and to the network, block 168. Each group call member's mobile station and the network stores the compressed list for the duration of the group call, block 170. Note that for mobile initiated group calls, the initiating mobile may send the compressed list to the network as part of the call setup, or prior to the call setup. The network then sends the compressed list to each group member. For non-mobile initiated group calls (such as an internet PC dispatch client originating a group call to multiple mobile subscribers), the mobiles within the group receive the compressed group list as part of the call setup.

A compressed group call member list may already be stored in the network by prior caching or provisioning actions (e.g. through a computer link to a web page in the network infrastructure).

For speaker arbitration, that is which of the members of the group call is being assigned the present right to speak, only the member's index number need be sent to each of the other members in the group call, block 172. Optionally, along with the member's index the state or presence information indicator may be sent, but only if it has been changed recently, block 174. The process is then ended.

Referring to FIG. 4, a call flow diagram is shown for use of the compressed address of record method is shown. Three members (MS1, MS2 and MS3) of a group call are shown. Group call members MS1, 2 and 3 are coupled through a network and use internet protocol. This example assumes the network has obtained the group member list, as identified by the group identifier AOR, prior to call setup. Messages 180-186 comprise the call setup. Member 1 is deemed to initiate the group call by sending invite message 180 which includes the full address of record for the group call identification to the network.

The network executes the compression method as shown above and generates the compress list 120 which the network returns via message 182 to member 1; via message 184 to member MS2 and via message 186 to member 3. Each group member in the call now has the compressed list of group call members which may include the presence or state indication as mentioned above.

The next phase of the call follows the speaker arbitration phase which includes steps 188 to 194. MS2 sends a request for message 188 indicating that member 2 is desiring to speak. Message 188 is sent from member 2 to the network. The network grants MS2 and member 2 the floor and sends a grant floor message 190 which includes index 2 representing member 2 as the speaker and the presence information to MS1. Similarly, network sends a grant floor message 192 to MS2 with index 2 and the presence information. Lastly, the network sends grant floor message 194 including index 2 and presence indicator for index 2 to MS3 for group call member 3. Each of the mobile stations MS 1 through MS3 now indicates to its respective member that member 2 has been granted the floor to speak and further member 2's presence information if updated is also provided.

Since member ID among the members of group call must be conveyed often, a simple relative index number is sent to each of the group call members instead of the full address of record information. The present method compresses the address of recognition for each of the members of group call. After this compression, only the relative number indicating the speaking member is transmitted thereafter. Optionally, presence or state information may be included with the speaker's relative index number.

The preferred embodiment illustrates the invention with a mobile station as the client device, however it will be apparent to those skilled in the art that other terminals or station including, but not limited to, personal digital assistants, wearable devices, pagers, phone, laptops and desktops may be used as well.

Although the preferred embodiment of the invention has been illustrated, and that form described in detail, it will be readily apparent to those skilled in the art that various modifications may be made therein without departing from the spirit of the present invention or from the scope of the appended claims.

1. A method for message compression for a group call using internet protocol (IP) over a network comprising the steps of:
providing a list including a plurality of members for a group call, each of the plurality of members having a complete address of record (AOR);
compressing the list to provide a compressed list including a unique identifier for each of the plurality of members; and
transmitting the compressed list to each of the plurality of members.

2. The method for message compression as claimed in claim 1, wherein the step of compressing includes the step of assigning to each of the plurality of numbers a distinct index number to represent each of the plurality of members.

3. The method for message compression as claimed in claim 1, wherein there is further included a step of grouping each of the plurality of members having a domain name in common.

4. The method for message compression as claimed in claim 3, wherein there is further included the steps of:
listing the domain name;
sequentially listing each of the plurality of members having a same domain name and the distinct index number associated with each of the plurality of members.

5. The method for message compression as claimed in claim 4, wherein there is further included a step of iterating the steps of listing and sequentially listing for each of a plurality of domain names to produce the compressed list.

6. The method for message compression as claimed in claim 5, wherein there is further included a step of associating with each of the plurality of members presence information in the compressed list.

7. The method for message compression as claimed in claim 6, wherein there is further included a step of transmitting the compressed list to each of the plurality of members at a beginning of the group call.

8. The method for message compression as claimed in claim 6, wherein there is further included a step of transmitting the compressed list to each of the plurality of members during the group call.

9. The method for message compression as claimed in claim 7, wherein there is further included a step of storing the compressed list by a mobile station of the plurality of members.

10. The method for message compression as claimed in claim 7, wherein there is further included a step of storing the compressed list by the network.

11. The method for message compression as claimed in claim 1, wherein the step of compressing includes a step of assigning to each of the plurality of members in the group call a modified address of record including a unique index for a duration of the group call.

12. The method for message compression as claimed in claim 11, wherein the step of compressing further includes a step of providing a presence indication for each of the plurality of members of the group call.

13. The method for message compression as claimed in claim 1, providing within the compresses list presence information for each of the plurality of members.

14. The method for message compression as claimed in claim 1, wherein the step of providing includes a step of providing a list by a first member of the plurality of members of the group call.

15. The method for message compression as claimed in claim 1, wherein the step of transmitting includes a step of transmitting the compressed list to a first member and to the plurality of members of the group call.

16. The method for message compression as claimed in claim 1, wherein:
the step of compressing includes a step of assigning a unique index number to each of the plurality of members of the group call; and
a first member of the plurality of members requesting to speak to each of the plurality of members.

17. The method for message compression as claimed in claim 16, wherein there is further included a step of transmitting the unique index number to each of the plurality of members.

18. The method for message compression as claimed in claim 1, wherein there is further included a step of modifying the compressed list to include additional members during the group call.

19. A method for compressing an address of record for a group call over a network comprising the steps of:
providing a list having an address of record (AOR) for each of a plurality of members of the group call;
compressing by the network the list including the address of record for each of the members into a compressed list including a domain name, a member ID and unique identifier; and
transmitting the compressed list to each of the plurality of members.

20. The method for compressing an address of record as claimed in claim 19, wherein there is further included a step of requesting by the first member to the network to be a speaker for the group call.

21. The method for compressing an address of record as claimed in claim 20, wherein:
the unique identifier for each of the plurality of members includes a unique index number; and
there is further included a step of transmitting by the network the unique index number of the first member to each of the plurality of members.

22. The method for compressing an address of record as claimed in claim 21, wherein there is further included a step of providing presence information corresponding to the unique index number of each of the plurality of members.
